(19) United States
(12) Patent Application Publication
(10) Pub. No.: US 2008/0267191 A1
(43) Pub. Date: Oct. 30, 2008

(54) Apparatus and method for multiple stage media communications

(75) Inventors: Don L. Smitheimer, Morganville, NJ (US); Alex Mendoza, West New York, NJ (US)

Correspondence Address: VONAGE, 23 MAIN STREET, HOLMDEL, NJ, 07733, US

(73) Assignee: Vonage Network Inc.

(21) Appl. No.: 11/796,177

(22) Filed: Apr. 27, 2007

(51) Int. Cl. H04L 12/28

(52) U.S. Cl. 370/395.5

(57) ABSTRACT

A method and system for multi-stage media communications a means for transmitting and receiving media messages via a two-stage communications protocol and a means for relaying the media messages via the two-stage communications protocol to one or more additional means for transmitting and receiving. The two-stage communications protocol includes a first RF-based stage and a second IP-based stage. The second IP-based stage uses SIP for establishing media communications between the means for transmitting and receiving media messages. Preferably, the system includes one or more wireless handheld devices for sending and receiving media and a base station device for relaying such media. Additional base stations can be added (via an IP network) to increase communications range without complex networking infrastructure.

### FIELD OF THE INVENTION

The invention is related to the field of telecommunication devices and services and more specifically, the invention is directed to an apparatus for permitting selective one-to-one, one-to-many or many-to-many communication sessions within a relatively small geographical area, but with scalability to reach beyond the geographical area with relatively small supporting infrastructure.

### BACKGROUND OF THE INVENTION

Existing communication systems such as Public Switched Telephone System (PSTN) and cell-based telephony systems can be used to connect one party to another (“one-to-one”) or connect many party's together (such as a conference or “many-to-many”) in Full-Duplex communication. These communications systems require a large and complex supporting infrastructure and cover a large geographically bounded area. Further, the PSTN is a hardwire system and, as such, is not mobile. Over the years, attempts have been made to improve mobility of the PSTN with devices like the cordless phone device; however, even these improvements are limited in their end result. Cell-phone based telephony systems provide a greater degree of mobility. Unfortunately, these systems require the presence, within relatively small geographically bounded areas, of a large and complex network of cellular towers to handle cellular communication.

By contrast, another technology using Half-Duplex communication, widely referred to as “walkie-talkie”, covers a very small geographically bounded area and requires no supporting infrastructure. Unfortunately, walkie-talkie communication systems offer little or no privacy. In general, this technology does not currently prevent passive eavesdropping or interference from others within the same geographically bounded area using an RF receiver tuned to the same frequency as users of the system.

Accordingly, it would be desirable to have a communication system that permits selective one-to-one or one-to-many and many-to-many communication sessions within a relatively small geographically bounded area, but with scalability to reach beyond geographically-bounded areas yet requiring relatively small supporting infrastructure.

### SUMMARY OF THE INVENTION

The disadvantages associated with the prior art are overcome by a method and system for multiple stage media communications. The system includes a means for transmitting and receiving media messages via a two-stage communications protocol and a means for relaying the media messages via the two-stage communications protocol to one or more additional means for transmitting and receiving. The two-stage communications protocol includes a first RF-based stage and a second IP-based stage. The second IP-based stage uses SIP for establishing media communications between the means for transmitting and receiving media messages. Preferably, the system includes one or more wireless handheld devices for sending and receiving media and a base station device for relaying such media. In this way, the system is capable of relaying media messages between two or more handheld devices within a first network area and between one or more handheld devices in the first network area and one or more handheld devices in a second or more network areas that are geographically separate from the first network area.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a system level block diagram of an exemplary SIP-based RF telecommunications system in accordance with the present invention;

FIG. 2 is a schematic diagram of an exemplary mobile communications device (handheld) for use in the present invention;

FIG. 3 is a schematic diagram of an exemplary server communications system (base station) for use in the present invention;

FIG. 4 is a logical data flow/diagram of an exemplary mobile device and user registration process of the present invention;

FIG. 5 is a logical data flow diagram of an exemplary handheld device to multiple recipients communication process of the present invention; and

FIG. 6 illustrates an exemplary handheld user interface.

To facilitate understanding, identical reference numerals have been used, where possible, to designate identical elements that are common to the figures.

### DETAILED DESCRIPTION

One popular communication protocol is the Session Initiation Protocol (SIP) which is a signaling protocol for initiating, managing and terminating media (e.g., voice, data and video) sessions across packet based networks that typically use the Internet Protocol (IP) of which VOIP is an example. The details and functionality of SIP can be found in the Internet Engineering Task Force (IETF) Request for Comments (RFC) Paper No. 3261 entitled, “SIP: Session Initiation Protocol” herein incorporated in its entirety by reference. SIP establishes and negotiates a session, including the modification or termination of a session. It uses a location-independent address system feature in which called parties can be reached based on a party's name. SIP supports name mapping and redirection allowing users to initiate and receive communication from any location. As such, it presents a solution to the infrastructure and scalability problems of existing PSTN, mobile and Walkie-Talkie communication systems as described below.

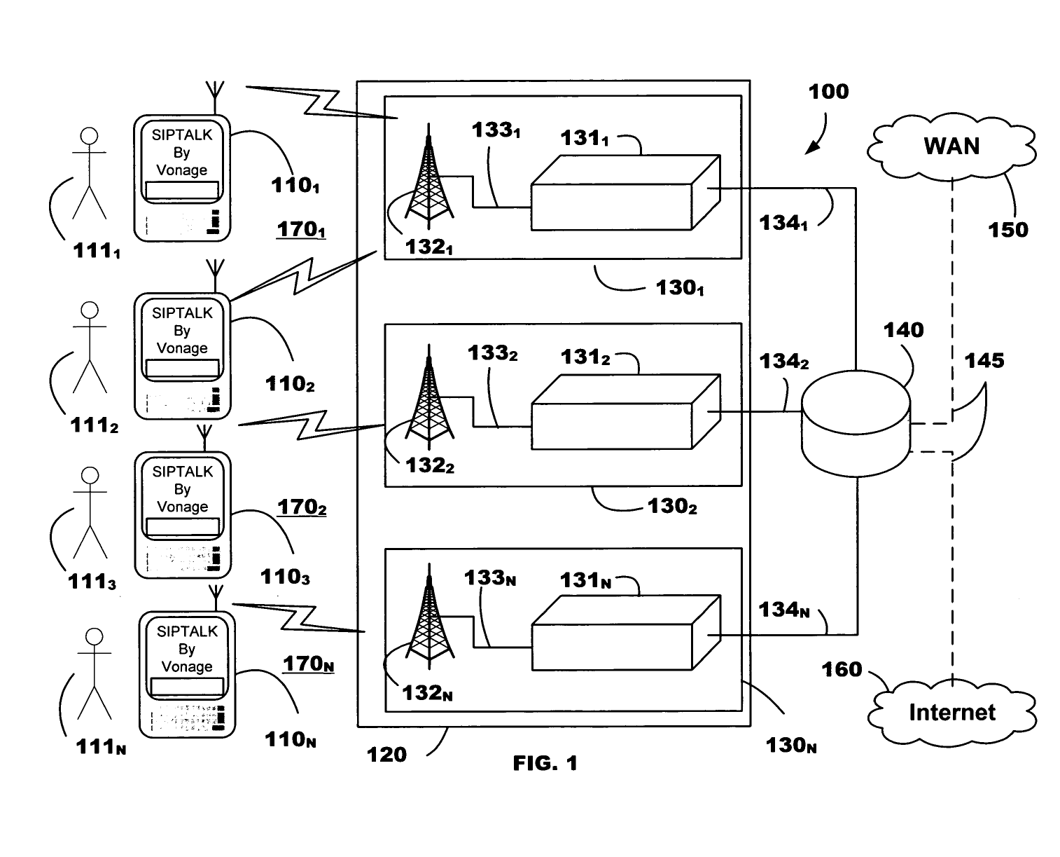

FIG. 1 is a system level block diagram depicting a structure of a two-way personal communications system 100 operating via a two-stage communication protocol according to an embodiment of the present invention. The system 100 includes a plurality of mobile communication devices 110ₓ, also known as handheld devices, which are used by a plurality of users 111ₓ for interaction with each other. The system 100 also includes a base station network 120 adapted to network the plurality of users 111ₓ across different geographically bounded regions. The users 111ₓ communicate with each other via a two stage communication protocol. In one embodiment of the invention, the two stage communication protocol includes a Radio Frequency (RF) protocol and a SIP/IP protocol as explained in greater detail below.

The base station network 120 includes a plurality of base stations 130n interconnected by one or more packet-based network devices 140. The network device(s) 140 is adapted to receive one or more internal connections 134ₓ for connecting the plurality of base stations 130ₙ thereto and one or more external connection 145 for optionally connecting the network device(s) 140 to one or more external networks such as but not limited to a Wide Area Network (WAN) 150 and the public Internet 160. That is, external connections 145 are shown in broken-line format to indicate that they are not part of the subject inventors and system 100, but may be optionally connected thereto to increase scalability of the inventive system 100. Each base station 130ₙ is provided with the necessary equipment (hardware and software) to transmit and receive two stage communication protocol signaling between two or more users 111ₓ. Specifically, each base station 130n includes a base station communication server 131, an antenna 132, a connection 133 between the server 131 and the antenna 132 and the internal network connection 134.

The plurality of handheld devices 110ₓ, are manipulated by users 111ₓ, to communicate with other users 111. A first local RF network 170₁, as defined herein consists of a Base Station 130 and a plurality handheld devices 110 which are capable of two-way RF communication. The Handheld devices 110 operate on the same or similar RF frequency as the base station 130ₓ and are connected to the base station 130 via an RF signaling protocol. The power output of an RF signal from the base station 130 and Handheld devices 110 coupled with the minimal power input of RF signal received by base station 130 and Handheld devices 110, defines the bounded geographical area defining the first local network 170₁, in which two-way RF communications is possible.

The subject invention provides the ability to expand the range of the first local RF network 170₁, to a second or more local RF networks 170₂₋ₙ. Essentially, the geographical area by which a plurality of handheld devices may communicate is increased by employing additional base stations 130₂, 130₃ . . . 130_{N} and interconnecting them via network device 140. In one embodiment of the invention, network device 140 is a Local Area Network (LAN) device such as a level 2 or level 3 switch as known in the art. Examples of such switches are the Catalyst 2960 manufactured and sold by Cisco Systems, Inc. of San Jose, Calif. and BigIron RX series layer 2/3 switches manufactured and sold by Foundry Networks, Inc. of Santa Clara, Calif. Further expansion is possible by employing WAN 150 and/or the Internet 160 to reach additional base stations (not shown).

For the first protocol of the two-stage communication protocol, the Handheld devices 110ₓ transmit and receive some type of media, such as audio, video, text, to other Handheld devices 110_{X} within the same RF network (i.e., first RF network 170₁) via the Base Station 130₁ to which they are connected. For the second protocol of the two-stage communication protocol, the Handheld devices 110ₓ, using the SIP over IP, establish a session with its associated base station 130, impart instructions to the base station such as the intended recipients and transfers the media via RF to the base station 130, which in turn transfers the media to the intended recipients.

Each Handheld device 110ₓ is manufactured with a unique identifying code (discussed in greater detail below) as known to those skilled in the telecommunication arts. In theory, the user 111ₓ of a handheld device 110ₓ logs in to his/her device with a username/password predetermined as unique within the set of usernames known by the local RF network 170ₙ. The base station 130 and handheld devices 110ₓ associate a user's username to the handheld ID on which the user logged on.

Handheld devices 110ₓ are configurable to set the same speech encoding and decoding type (CODEC) as other handheld devices 110ₓ and the base station 130 within an RF network 170ₓ. The configurable capability removes the necessity of supporting the Session Description Protocol (SDP). The handheld devices 110ₓ may be manufactured with a number of CODECS programmed and in one embodiment, the handheld device 110ₓ and base station 130 will be able to adjust the CODEC for that handheld device automatically to improve its Quality of Service.

In one embodiment, the handheld devices 110ₓ are in periodic RF communication with the base station 130ₓ in its RF network 170ₓ. If the Base Station 130ₓ does not receive a “heartbeat” after a pre-determined period, the base station 130ₓ assumes the handheld device 110ₓ has been turned off or is too far from the Base Station 130ₓ to have its signal received. The pre-determined period may be constant (i.e., continuous “heartbeat” signals) or of longer periodicity (i.e., one “heartbeat” signal per minute).

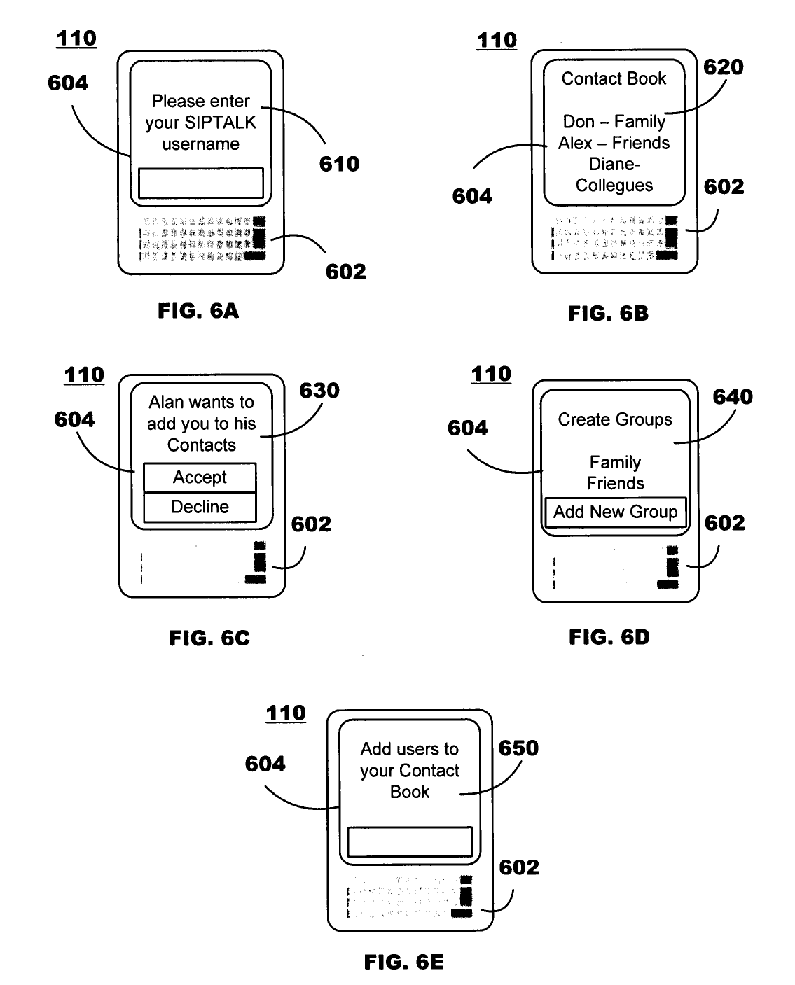

In one embodiment of the invention, the handheld devices 110ₓ are configurable and expandable by their users 111ₓ with actions selected from the group consisting of adding/deleting contacts in an “address book” type application, and adding/deleting groups of users. Such actions are executed via one of more interfaces that are part of the handheld device 110. For example, FIGS. 6A-E depict a plurality of different interface screens that are generated in executing a corresponding plurality of different user functions including but not limited to sign on and configurability options. In each instance, a handheld device 110 is depicted as having an interface display screen 604 displaying a message 6×0 appropriate to the action being taken and a keypad 602 for entering data corresponding to the action being taken. In one embodiment, the keypad 602 is of alphanumeric design in the QWERTY format having individual, physical buttons for each desired character. In an alternate embodiment, the keypad 602 is displayed as a part of or all of the display screen 604 using a touchpad technology as known in the art. In greater detail, FIG. 6A displays a first message 610 used during a user registration process (discussed in greater detail below). FIG. 6B displays a second message 620 used during an address book look up function. FIG. 6C displays a third message 630 used during a third party address book request function. FIG. 6D displays a fourth message 640 used during an address book “group” edit function. FIG. 6E displays a fifth message 650 used during an address book edit function. In an alternate embodiment, any or all of such functions displayed here or others are executed via a voice command prompt system in addition to or in place of the display screen messages; a suitable system being known to those skilled in the art.

Base Stations 130ₓ maintain RF communication with the handheld devices 110ₓ to update a contact list or address book associated with a particular handheld device or provide a broadcast ability in which a base station application may broadcast a message to all of the handheld devices 110ₓ within the RF network 170ₓ. Base Stations 130ₓ monitor-the condition of all handhelds 110ₓ within the RF network 170ₓ and may update the address books of users effected by other users. For example, in one embodiment of the invention, one method is to greyout the username in an address book should that user log off or power off their device or move beyond range of the Base Station 130ₓ, or elect a Do Not Disturb (DND) mode on their Handheld device 110ₓ.

Handheld devices 110ₓ associated with the subject invention communicate with each other indirectly over RF via the base station 130ₓ. Specifically, in one embodiment of the invention, handheld devices transmit and receive on two different frequencies. The base station 130ₓ within the RF network 170ₓ receives on the same frequency the handheld devices 110ₓ transmit. Similarly, the base station 130ₓ within the RF network 170ₓ transmits on the same frequency the handheld devices 110ₓ receive. In this way, interference is eliminated (i.e., one or more handheld devices will not receive a transmission from other handheld devices within transmission range. Another method may be to utilize the Spread Spectrum technologies such as Direct Sequence Spread Spectrum (DSSS) or Frequency Hopping Spread Spectrum (FHSS) as known to those skilled in the art.

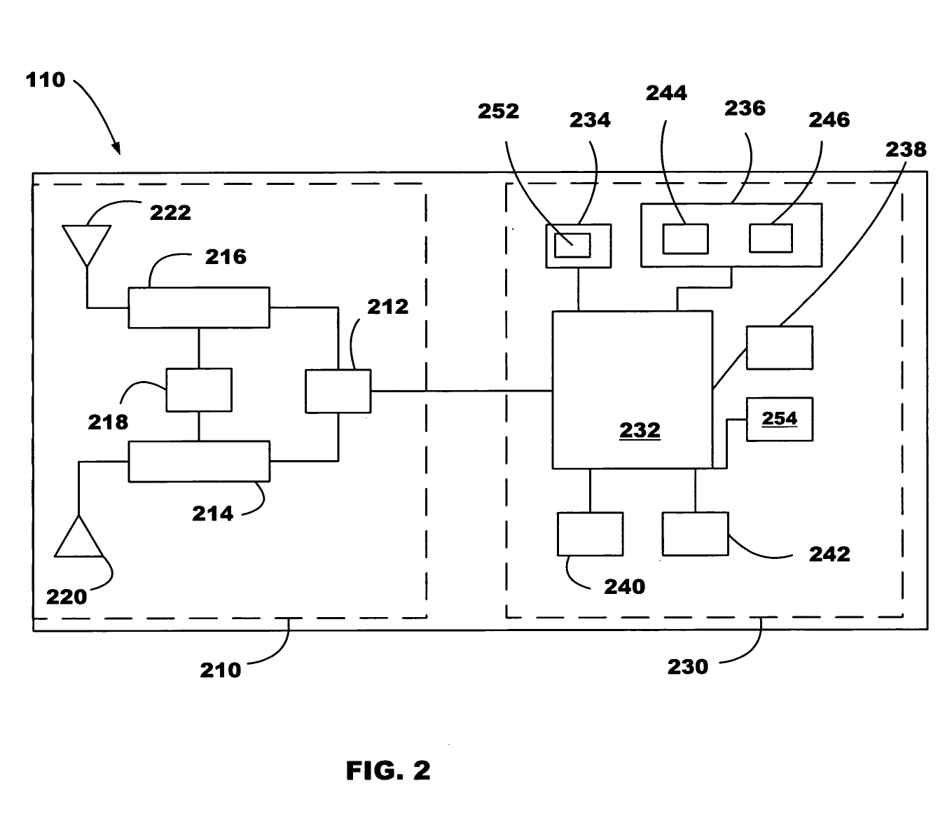

FIG. 2 depicts a schematic diagram of an exemplary handheld device 110 that may be used in accordance with and to practice the present invention. The handheld device 110 contains a plurality of components and or modules that facilitate execution of the inventive two stage communication protocol. Specifically, the handheld device 110 includes an RF transmission processor 210 connected to a packet processor 230. In a preferred embodiment of the invention, the packet processor 230 is an IP packet processor.

The RF transmission processor 210 includes the necessary components and/or programming to perform RF transmission and receiving functions of the handheld device 110. In detail, the RF transmission processor 210 includes digital signal processor (DSP) 212 for performing signal modulation/demodulation and encoding/decoding tasks. The DSP 212 is connected to a transmitter means 214 and a receiver means 216 which respectively perform upconverting (analog-to-digital) and downconverting (digital-to-analog), amplification and mixing of signals comprising a voice session between users. The transmitter means 214 and receiver means 216 are also connected to an oscillator 218 which provides the baseband or carrier signal upon which the voice data is mixed or carried. Additionally, each of the transmitter means 214 and a receiver means 216 has an antenna 220/222 for respectively transmitting and receiving signals between users. Alternately, one antenna is used in the RF transmission processor 210. In such an arrangement, a switch (not shown) is connected between the one antenna and receiver means 216 and transmitter means 214. When the button is depressed on the handset 110 (i.e., a Push-To-Talk (PTT) button) the transmitter means 214 is connected to the one antenna and when the button is not depressed, the receiver means 216 is connected to the one antenna.

The packet processor 230 includes the necessary components and/or programming to perform processing of data (i.e., converted voice signals) according to SIP in the handheld device 110. The packet processor 230 comprises a central processing unit (CPU) 232, one or more memories 234/236, and support circuits 238 for the CPU 232 and provisions 240/242 for interfacing with the handheld device 110. One example of such provisions may be input/output devices such as a display screen and keyboard. The CPU 232 is connected to the DSP 212 for managing and controlling packet processing. The CPU 232 may be one of any form of a general purpose computer processor used in packet-based networks for executing machine instructions. The memories or computer-readable medium 234/236 are coupled to the CPU 232 and can be one or more of readily available memory such as random access memory (RAM), read only memory (ROM), floppy disk, hard disk, flash memory or any other form of digital storage, local or remote. The support circuits 238 are coupled to the CPU 232 for supporting the packet processor in a conventional manner. These support circuits include cache, power supplies, clock circuits, input/output circuitry and subsystems, and the like.

The packet processor 230 further includes a plurality of modules for dedicated task processing. In one embodiment of the invention, the plurality of modules is selected from the group consisting of a Media Handler module 244, a SIP processing module 246 and a Real Time Protocol (RTP) Handler module 254. Specifically, these modules are represented as dedicated software routines contained in at least one of the memories 234/236. Such modules will cause the packet processor 230 to perform processes necessary to the present invention. For example, the SIP processing module 246 is executed to handle SIP-related communication functions, the Media Handler module 244 is executed to handle different types of media (i.e., voice, video, speech to text, text to speech, etc.) and the Real Time Protocol (RTP) Handler module 254 is executed to handle RTP-related media functions.

A general software routine 252, when executed by the CPU 232, causes the packet processor 230 to perform processes of the present invention (such as but not limited to setting up and tearing down voice communication sessions described in greater detail below and calling one or more dedicated software routines such as but not limited to those identified above) and is generally stored in one or more of the memories 234/236. The software routine 252 may also be stored and/or executed by a second CPU (not shown) that is remotely located from the hardware being controlled by the CPU 232. For example, the software routine 252 may be stored (in part) in a memory of the handheld device 110 and stored (in part) in a memory of the base station 130ₓ (described in greater detail below). The software routine 252, when executed by the CPU 232, transforms the handheld device 110 into a specific purpose computer that performs voice communications via the two stage communication protocol. Although a portion of the present invention is discussed as being implemented as a software routine, some of the method steps that are disclosed may be performed in hardware as well as by the packet processor 230. As such, the invention may be implemented in software as executed upon a computer system, in hardware as an application specific integrated circuit or other type of hardware implementation, or a combination of software and hardware.

The software routine 252 of the present invention is capable of being executed on computer operating systems including but not limited to Microsoft Windows 98, Microsoft Windows XP, Apple OS X and Linux. Similarly, the software routine 252 of the present invention is capable of being performed using CPU architectures including but not limited to Apple Power PC, Intel x86, Sun SPARC and Intel ARM.

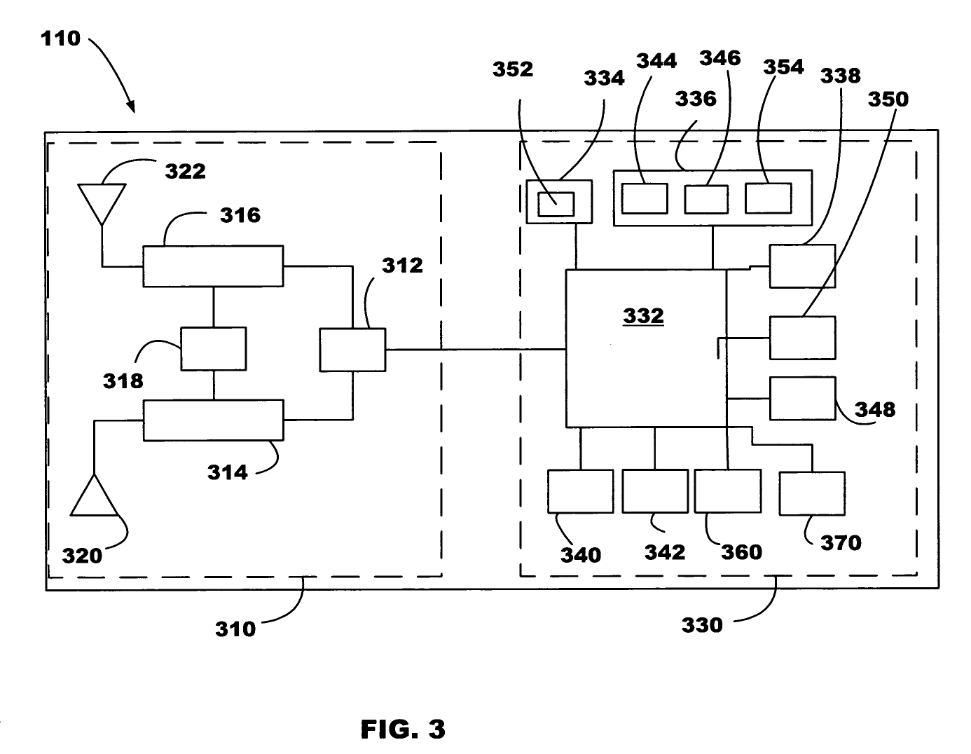

FIG. 3 depicts a schematic diagram of an exemplary base station server 131 that may be used in accordance with and to practice the present invention. The base station server 131 contains a plurality of components and or modules that facilitate execution of the inventive two stage communication protocol. It is noted that all components identified in the handheld device 110 have corresponding components in the base station server 131 with corresponding interconnection and function; hence, they need not be specifically repeated herein but are briefly described. Specifically, the base station server 131 includes an RF transmission processor 310 connected to a packet processor 330. The RF transmission processor 310 includes the necessary components and/or programming to perform the RF transmission and receiving functions of the base station server 131. The RF transmission processor 310 includes digital signal processor (DSP) 312 similar in form and function to that of the handheld device 110. The DSP 312 is connected to a transmitter means 314 and a receiver means 316 similar in form and function to that of the handheld device 110. The transmitter means 314 and receiver means 316 are also connected to an oscillator 318 similar in form and function to that of the handheld. Additionally, each of the transmitter means 314 and a receiver means 316 has an antenna 320/322 for respectively transmitting and receiving signals between users although a single antenna may alternately be employed as described above with respect to the handheld device 110.

The packet processor 330 includes the necessary components and/or programming to perform processing of data (i.e., converted voice signals) according to SIP in the base station server 131. The packet processor 330 comprises a central processing unit (CPU) 332, one or more memories 334/336, support circuits 338 for the CPU 332 and provisions 340/342 for interfacing with the base station server 131. Such provisions may be input/output devices selected from the group consisting of a display screen, a keyboard, a microphone and an audio transducer (i.e., speaker). One or more auxiliary input/output devices 370 may also be provided such as but not limited to a serial port and a network management port. Additional network ports may be used to cross-connect two base stations in an active-active or active-passive high availability configuration. The CPU 332 is connected to the DSP 312 for managing and controlling packet processing. The CPU 332 may be one of any form of a general purpose computer processor used in packet-based networks for executing machine instructions. The memories or computer-readable medium 334/336 are coupled to the CPU 332 and can be one or more of readily available memory such as random access memory (RAM), read only memory (ROM), floppy disk, hard disk, flash memory or any other form of digital storage, local or remote. The support circuits 338 are coupled to the CPU 332 for supporting the packet processor in a conventional manner. These support circuits include cache, power supplies, clock circuits, input/output circuitry and subsystems, and the like.

Similar to the handheld device packet processor 230, the base station packet processor 330 further includes a Media Handler module 344, a SIP processing module 346 and an RTP Handler module 354 all of which are similar in form (software representations in one or more memories 334/336) and function to that described for the handheld device 110. Additionally, the base station packet processor 330 further includes a database 348 for managing user information (i.e., user log in information, contact information/updates, storage of transient and permanent data such as but not limited to current session information and persistent group association, handheld ID user association, status of handheld devices, ON/OFF, DND settings by user and the like), an administration module 360 for managing basic system functions apart from the actual voice sessions (i.e., providing software for local administration of the base station 130) and a network module 350 for managing one or more network interfaces.

A software routine 352, when executed by the CPU 332, causes the packet processor 330 to perform processes of the present invention (such as but not limited to setting up and tearing down voice communication sessions described in greater detail below and calling one or more dedicated software routines such as but not limited to those identified above) and is generally stored in one or more of the memories 334/336. The software routine 352 may also be stored and/or executed by a second CPU (not shown) that is remotely located from the hardware being controlled by the CPU 332. For example, the software routine 352 may be stored (in part) in a memory of the base station server 131 and stored (in part) in a memory of the handheld device 110. The software routine 352, when executed by the CPU 332, transforms the base station 131 into a specific purpose computer that performs voice communication according to the two stage communication protocol. Although a portion of the present invention is discussed as being implemented as a software routine, some of the method steps that are disclosed may be performed in hardware as well as by the packet processor 330. As such, the invention may be implemented in software as executed upon a computer system, in hardware as an application specific integrated circuit or other type of hardware implementation, or a combination of software and hardware. Additionally, the handheld device software routine 252 and the base station software routine 352 may be considered as one two stage communication protocol software routine having specific or dedicated modules for executing handheld-specific and base station-specific tasks for the purposes of the subject invention.

The software routine 352 of the present invention is capable of being executed on computer operating systems including but not limited to Microsoft Windows 98, Microsoft Windows XP, Apple OS X and Linux. Similarly, the software routine 352 of the present invention is capable of being performed using CPU architectures including but not limited to Apple Power PC, Intel x86, Sun SPARC and Intel ARM.

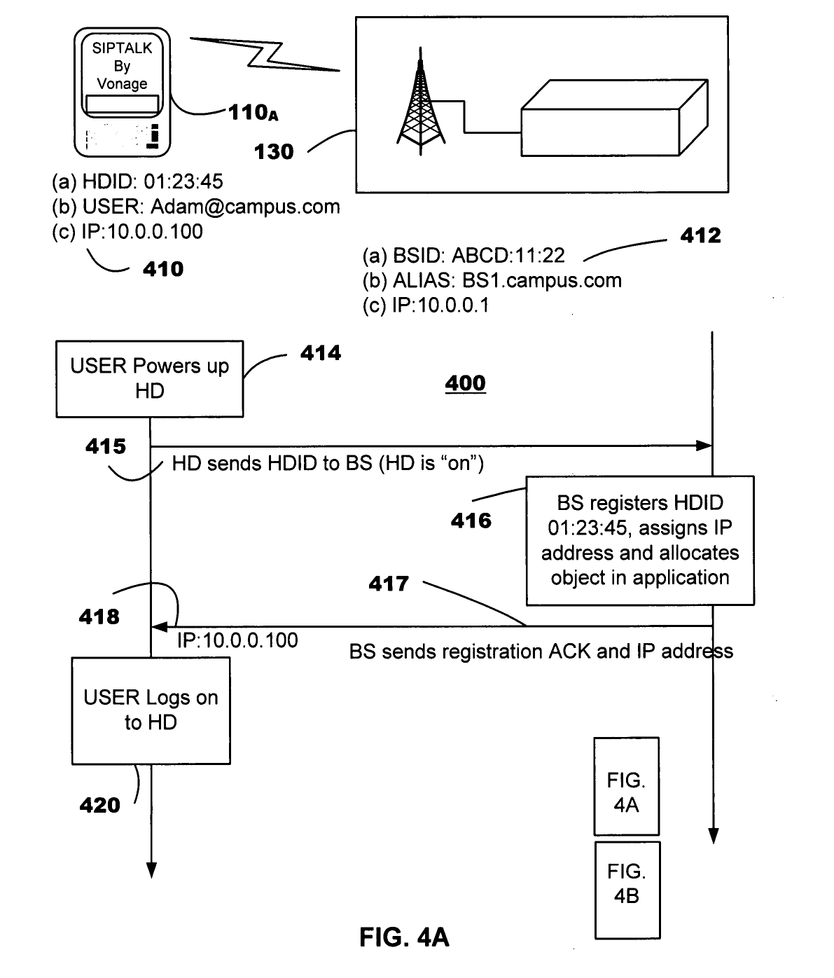

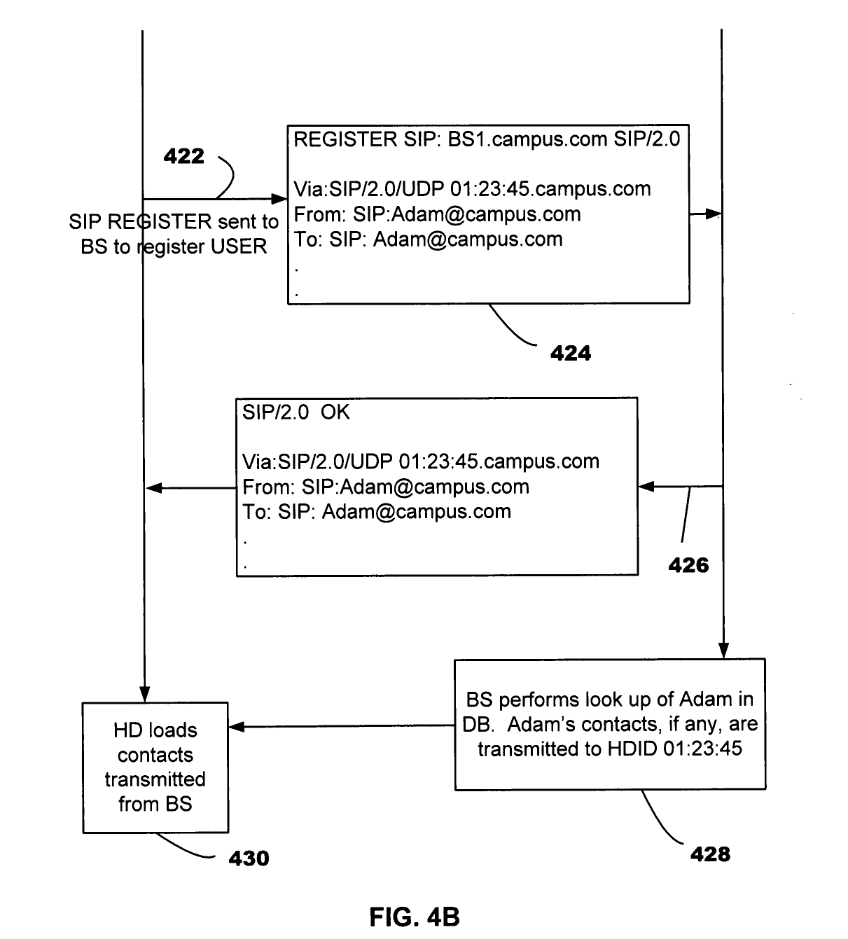

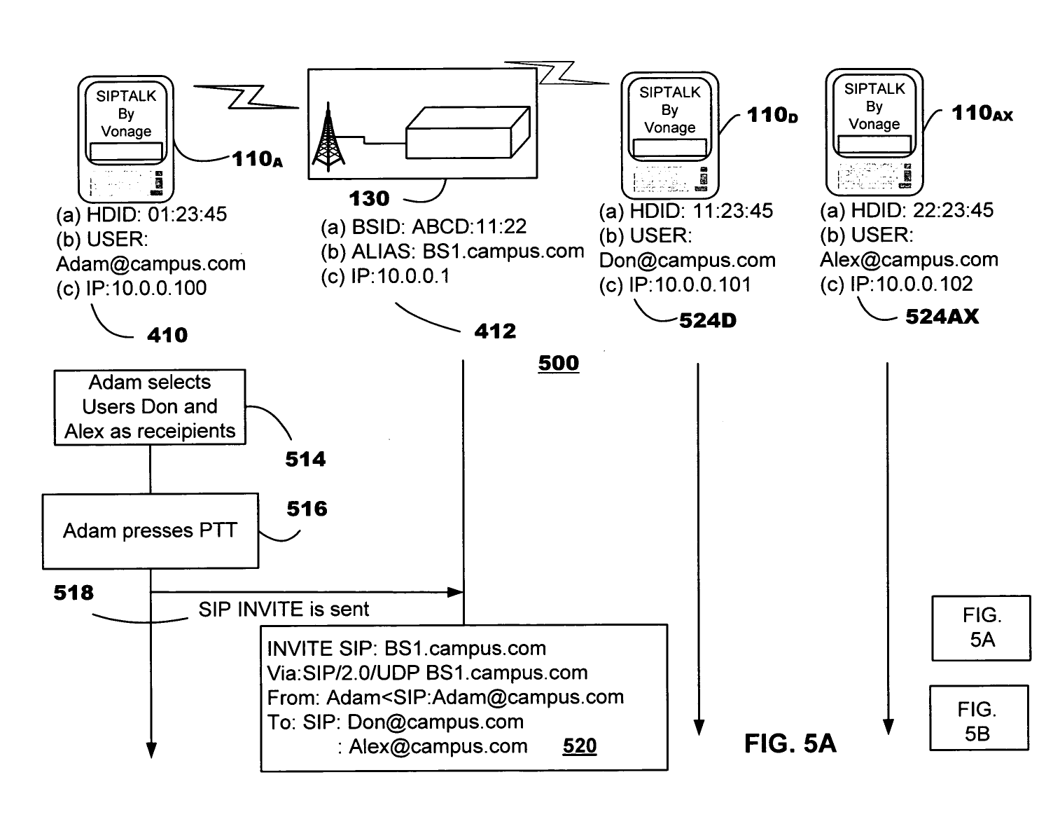

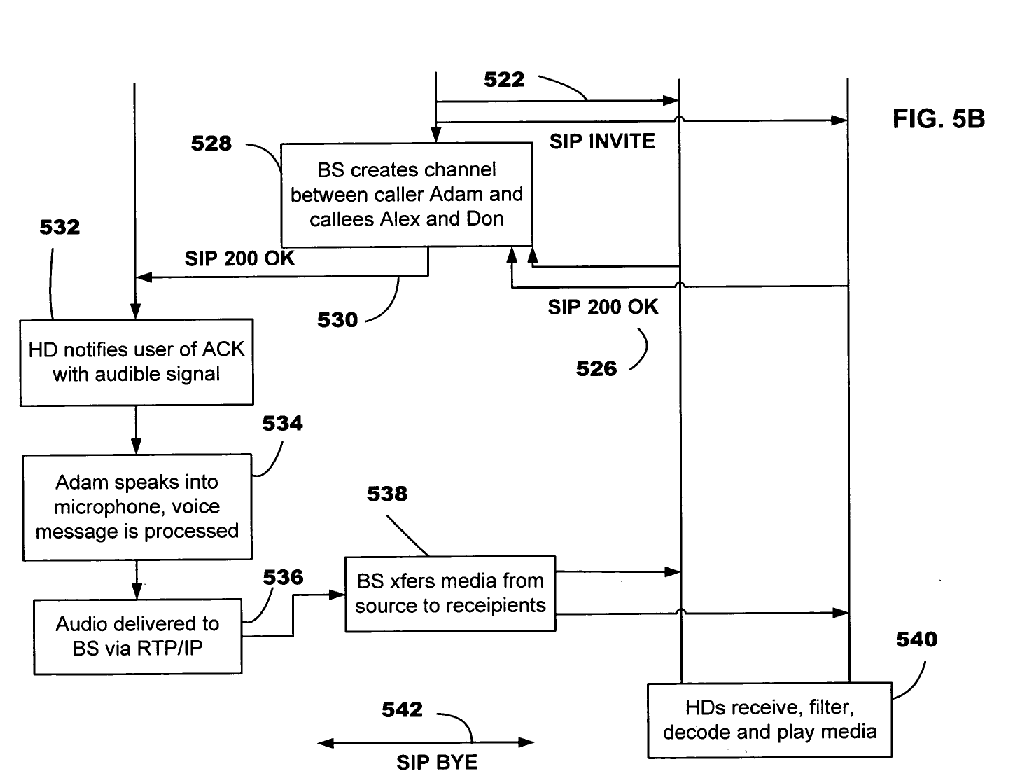

FIGS. 4 and 5 depict two exemplary uses respectively of the two stage communication protocol of the subject invention. Specifically, FIG. 4 depicts the data flow of a handheld device/user registration process 400 and FIG. 5 depicts the data flow of a handheld device-to-multiple recipient communication process 500. To facilitate understanding of the invention, the following description of the data flows and attendant processes of FIGS. 4 and 5 includes names to identify one or more of the users 111n and their respective handheld devices 110n discussed earlier. In one embodiment of the invention, the name “Adam” is associated with a first user 111_{A}, the name “Don” is associated with a second user 111_{D} and the name “Alex” is associated with a third user 111_{AX}.

Initially in the handheld device/user registration process 400, Adam has a handheld device 110 currently powered off and having an ID profile 410. Adam powers on the handheld device at step 414. During the device's operating system boot process at step 415, the handheld device 110 registers itself with the nearest or only base station 130 within its vicinity by sending the handheld device's ID #410A (e.g. 01:23:45) via an RF transmission. The base station 130 receives the RF transmission with embodied instructions requesting registration in a digitally encoded, non-SIP manner known to those skilled in the art. The base station 130 (in a previously booted-up condition prior to the Handheld 410 power on), is pre-configured with a profile 412 having a unique ID #, 412a, network alias or FQDN 412b and a IP address 412c.

The base station 130 registers the handheld 110 at step 416. In one embodiment, this registration occurs by allocating memory 334 to the database 348 for the handheld 110, assigning an IP address 410c to the handheld 110x and updating the database 348 with such IP address. The base station 130 responds to the handheld 110 with an acknowledgement code and the IP address in step 417. The handheld 110 receives the acknowledgment code and IP address at step 418, incorporates the IP address into its configuration, and completes the boot process presenting Adam with a login message such as first message 610.

At step 420, Adam enters his username on handheld 110. This action sends a SIP REGISTER message to the base station 130 at step 422. Record 424 depicts an exemplary SIP REGISTER message record which includes the SIP REGISTER instruction. At step 426, the base station 130 responds with a SIP OK message. Additionally, its application looks up Adam in its Database 348 for contact information, and transmits such information if it exists, to the handheld 110, at step 428. At step 430, the handheld 110 receives the contact information, if any, and loads it into its memory 234 thereby completing the registration process.

Turning to FIG. 5, the handheld device-to-multiple recipient communication process 500 is described as follows. From the address book (i.e. a page 620 depicted in FIG. 6B), Adam selects Don and Alex as callees or recipients with whom Adam would like to send a voice message at step 514. Adam then “keys-up” or presses the Push-to-Talk (PTT) button on the handheld device 110 at step 516. At step 518, the handheld 110 sends a SIP INVITE message which includes the recipients Don and Alex in the To field as shown in an exemplary SIP record 520. The INVITE message is sent to a base station 130 that has Adam's handheld device 110 registered.

At step 522, the base station 130 sends a SIP INVITE to each recipient handheld device 110_{D} & 110_{AX} first looking up in its database 348 for each recipient's user name to locate its Handheld devices ID 524 (D and AX respectively) and to determine if that Handheld device is powered on or in the range of the base station. Each Handheld device 110_{D} & 110_{AX} responds to the SIP INVITE with a SIP 200 OK at step 526. The base station 130 receives the SIP 200 message and at step 528, opens a channel by associating the IP address of the caller's handheld 110c with the IP address of each recipient's handheld 524 (D and AX respectively). At step 530, the base station 130 sends a SIP 200 OK to handheld 110. Upon receiving the SIP 200, the handheld 110 notifies Adam that the invite was accepted at step 532. Notification occurs by at least one of many known means including but not limited to an audible tone, a visual cue, a physical response (i.e., vibration), and others.

At step 534, Adam speaks into the device's microphone to generate a voice message. The device digitizes and compresses the voice message based on the CODEC implemented or selected on the handheld 110. The handheld 110 then packages the processed voice message into an RTP message and sends it to the base station 130 at step 536. The base station relays the processed voice message to each recipient on the channel at step 538. The Handheld devices 110_{D} & 110_{AX} receive the processed voice message, decode it and play the voice message on their speaker at step 540. After the base station 131 sends the voice message, it sends a SIP BYE message to “break” down the channel at the final step 542.

Optionally, the handheld devices retain the contact recipients for a period of time to preclude the user from having to re-select each recipient, either users or groups, each time the user wants to send media. The user may change the selected recipients at any time. Additionally, the recipient handheld devices receive the recipient list in the SIP INVITE message and with it they configure their contact recipient list in the event that handheld's user presses PTT to send a media to the same recipients and caller in response.

In another embodiment of the present invention, a first user presses and speaks voice commands into a small lapel-worn mobile communication device. The voice commands instruct the base station 130ₓ as to whom the caller wishes to communicate with, the intended recipients or callees. The command(s) are transmitted via RF to the Base Station 130ₓ within the RF network 170ₓ. The base station 130ₓ invites the callee's mobil communication device using SIP, thereby opening a “channel” to the callee's devices. Conversation occurs only via the open channel in a half-duplex fashion so that all parties may converse without the need to key-up or perform a “Press-to-Talk” (PTT) operation. When a user presses the small mobil communication device again it sends a SIP BYE message to the base station 130ₓ ending the conversation. When all of the devices on the open channel have issued a SIP BYE, either when keyed or through voice command such as “OUT”, the channel is closed.

While foregoing is directed to embodiments of the present invention, other and further embodiments of the invention may be devised without departing from the basic scope thereof, and the scope thereof.

1. A system for media communications comprising:
a means for transmitting and receiving media messages via a two-stage communications protocol; and
a means for relaying the media messages via the two-stage communications protocol to one or more additional means for transmitting and receiving.

2. The system of claim 1 wherein the two-stage communications protocol further comprises a first RF-based stage and a second IP-based stage.

3. The system of claim 2 wherein the second IP-based stage uses SIP for establishing media communications between the means for transmitting and receiving media messages.

4. The system of claim 3 wherein the means for transmitting and receiving is a wireless handheld device.

5. The system of claim 4 wherein the wireless handheld device further comprises an RF transmission processor and an IP packet processor.

6. The system of claim 3 wherein the means for relaying the media messages is a base station device.

7. The system of claim 6 wherein the base station device further comprises an RF transmission processor and an IP packet processor.

8. The system of claim 1 wherein the means for relaying is capable of relaying media messages in a manner selected from the group consisting of between two or more transmitting and receiving means within a first network area and between one or more transmitting and receiving means in the first network area and one or more transmitting and receiving means in a second or more network areas.

9. The system of claim 1 wherein the media is selected from the group consisting of audio, video, text/SMS messages and data.

10. A method of performing media communications comprising:
notifying one or more recipients of an incoming media message via a two-stage communication protocol;
generating the media message;
transmitting the media message to the one or more recipients via the two-stage communication protocol.

11. The method of claim 10 wherein the two-stage communication protocol further comprises a first RF-based stage and a second IP-based stage.

12. The method of claim 11 wherein the step of notifying further comprises sending a notification message via first RF stage.

13. The method of claim 11 wherein the notification message is a SIP-based command.

14. The method of claim 13 wherein the SIP-based command is INVITE.

15. The method of claim 11 wherein the step of generating the media message further comprises creating, digitizing and compressing a voice message.

16. The method of claim 11 wherein the step of transmitting the media message further comprises establishing a communication channel subsequent to receipt of SIP-based messaging.

17. The method of claim 16 wherein the communication channel is an RTP channel established after receipt of a SIP 200 “OK” message.

18. The method of claim 16 wherein the step of transmitting further comprises transmitting the media message via an RTP channel that traverses the first RF-based stage and a second IP-based stage.

19. The system of claim 10 wherein the media message is selected from the group consisting of audio, video, text/SMS messages and data.

20. A system for media communications comprising:
a handset for transmitting and receiving media messages via a two-stage communications protocol; and
a base station for relaying the media messages via the two-stage communications protocol to one or more additional handsets;
wherein the two stage communications protocol includes a first RF-based stage and a second IP-based stage.

21. The system of claim 1 wherein the media is selected from the group consisting of audio, video, text/SMS messages and data.
